(19) United States
(12) Patent Application Publication
(10) Pub. No.: US 2026/0348754 A1
(43) Pub. Date: Nov. 5, 2026

(54) Anomaly Detection in Microgravity Environments using Time Series Data of Autonomous Floaters

(71) Applicant: International Business Machines Corporation, Armonk, NY (US)

(72) Inventors: Steven Lee Fisher-Stawinski, Buffalo Grove, IL (US); Naeem Altaf, Round Rock, TX (US); John Stern Alexander, Hampstead, NC (US); Charles Palmer, Hanover, NH (US); Neil Delima, Scarborough (CA)

(21) Appl. No.: 19/196,087

(22) Filed: May 1, 2025

(51) Int. Cl. G01F 23/30; G06F 17/18

(52) U.S. Cl. CPC G01F 23/303; G06F 17/18

(57) ABSTRACT

Statistical anomaly detection is provided. A statistical analysis is performed of time series data representing a thrust vector performed by an autonomous floater. An anomaly is detected in a chamber in which the autonomous floater is located based on the statistical analysis of the time series data representing the thrust vector performed by the autonomous floater.

### BACKGROUND

The disclosure relates generally to anomaly detection and more specifically to detecting anomalies using statistical analysis.

Anomaly detection, or outlier detection, is the identification of data points, observations, or events that deviate from what is usual, standard, or expected, making them inconsistent with the rest of a data set. Anomaly detection has a long history in the field of statistics, looking for any elements that appear abnormal. Today, anomaly detection leverages artificial intelligence and machine learning to automatically identify unexpected changes in a data set's normal behavior. Anomalous data can signal incidents such as infrastructure failure, equipment defects, security threats, and the like.

In the context of time series data, anomaly detection involves detecting unusual patterns, abrupt changes, or unexpected seasonality in data collected over time. Anomalies in time series data might appear as an abrupt increase or decrease in values, odd patterns, or unexpected seasonality. A time series is a sequence of data points that occur in successive time order over some defined period. Typically, a time series is a sequence taken at successive equally spaced points in time. Thus, a time series is a sequence of discrete-time data. Anomaly detection in time series data may be accomplished using unsupervised learning approaches such as clustering, principal component analysis, autoencoders, and the like.

### SUMMARY

According to one illustrative embodiment, a method is provided. A computer performs a statistical analysis of time series data representing a thrust vector performed by an autonomous floater. The computer detects an anomaly in a chamber in which the autonomous floater is located based on the statistical analysis of the time series data representing the thrust vector performed by the autonomous floater. According to other illustrative embodiments, a computer system and computer program product are provided.

### BRIEF DESCRIPTION OF THE DRAWINGS

FIG. 1 is a pictorial representation of a computing environment in which illustrative embodiments may be implemented;

FIG. 2 is a diagram illustrating an example of an anomaly detection system in accordance with an illustrative embodiment; and

FIGS. 3A-3B are a flowchart illustrating a process for detecting anomalies in microgravity space environments in accordance with an illustrative embodiment.

### DETAILED DESCRIPTION

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A CPP embodiment is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

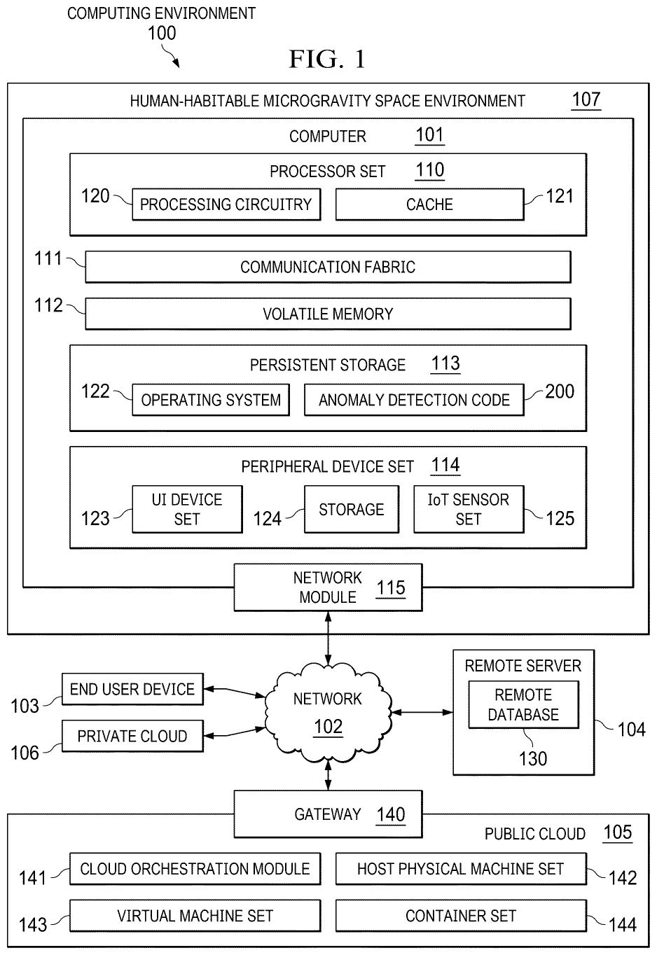

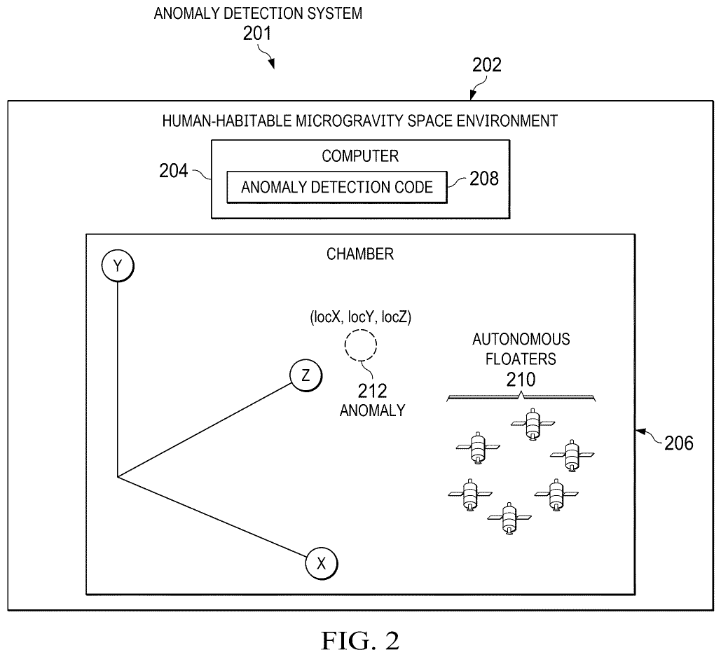

With reference now to the figures, and in particular, with reference to FIG. 1 and FIG. 2, diagrams of data processing environments are provided in which illustrative embodiments may be implemented. It should be appreciated that FIG. 1 and FIG. 2 are only meant as examples and are not intended to assert or imply any limitation with regard to the environments in which different embodiments may be implemented. Many modifications to the depicted environments may be made.

FIG. 1 shows a pictorial representation of a computing environment in which illustrative embodiments may be implemented. Computing environment 100 contains an example of an environment for the execution of at least some of the computer code involved in performing the inventive methods of illustrative embodiments, such as anomaly detection code 200.

For example, anomaly detection code 200 receives time series data from an autonomous floater located within a chamber. The chamber is filled with at least one of a gas and a liquid. The autonomous floater is neutrally buoyant in the gas or the liquid. The autonomous floater is configured to maintain a desired position within the chamber by thrusting. The autonomous floater is also configured to log the thrusting as time series data. The time series data representing a thrust vector performed by the autonomous floater. Anomaly detection code 200 records the time series data representing the thrust vector in a data store. The thrust vector corresponding to the autonomous floater includes at least one of a direction, a magnitude, and a duration of the thrusting performed by the autonomous floater over a period of time. Anomaly detection code 200 performs at least one statistical technique on the time series data recorded in the data store. The statistical technique is, for example, an anomaly detection algorithm or the like. Anomaly detection code 200 detects an anomaly in the chamber in which the autonomous floater is located based on the statistical technique. Anomaly detection code 200 interprets the anomaly as a leak in the chamber. In other words, the statistical technique is anomaly detection relative to a baseline thrust vector such that the anomaly so-detected is a leak in the chamber. Thus, the anomaly (i.e., the leak) causes a thrust vector deviation or difference from the baseline thrust vector (e.g., the leak causes the autonomous floater to increase thrusting to obviate or negate the pull of the autonomous floater toward the leak to maintain the desired or intended position of the autonomous floater within the chamber). The chamber is located within human-habitable microgravity space environment 107. Human-habitable microgravity space environment 107 encloses a human-breathable atmosphere. Human-habitable microgravity space environment 107 may be, for example, a spacecraft, a space station, a planetary landing module, a planetary station, or the like.

In addition to anomaly detection code 200, computing environment 100 includes, for example, computer 101, network 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and anomaly detection code 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, or any other form of computer now known or to be developed in the future that is capable of, for example, running a program, accessing a network, and querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In addition, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods of illustrative embodiments may be stored in anomaly detection code 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports, and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open-source portable operating system interface-type operating systems that employ a kernel.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks, and even connections made through wide area networks such as the internet. In various embodiments, UI device set 123 may include components such as a display screen, speaker, microphone, wearable devices (such as smart glasses and smart watches), keyboard, mouse, printer, touchpad, and haptic devices.

Storage 124 is external storage, such as an external hard drive, or insertable storage, such as an SD card. Storage 124 may be persistent and/or volatile.

IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers and devices through network 102. Network module 115 may include hardware, such as Wi-Fi signal transceivers, software for packetizing and/or de-packetizing data for communication network transmission, and the like. In some embodiments, network control functions and network forwarding functions of network module 115 are performed on the same physical hardware device. In other embodiments (e.g., embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

Network 102 is any type of network capable of communicating computer data over distances by any technology for communicating computer data, now known or to be developed in the future. In some embodiments, network 102 may be replaced and/or supplemented by satellites designed to communicate data directly between computer 101 of human-habitable microgravity space environment 107 and earth-based systems and devices, such as EUD 103, remote server 104, host physical machine set 142, and the like.

EUD 103 is any computer system that is used and controlled by an end user (e.g., an operations specialist who monitors the operation of human-habitable microgravity space environment 107), and may take any of the forms discussed above in connection with computer 101. EUD 103 typically receives helpful and useful data from the operations of computer 101. For example, in a hypothetical case where computer 101 is designed to provide a detected anomaly notification to the end user, this notification would typically be communicated from network module 115 of computer 101 through network 102 to EUD 103. In this way, EUD 103 can display, or otherwise present, the detected anomaly notification to the end user. In some embodiments, EUD 103 may be a client device, such as a thin client, heavy client, mainframe computer, desktop computer, laptop computer, tablet computer, smart phone, and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a detected anomaly notification based on deviation from historical baseline data, then this historical baseline data may be provided to computer 101 from remote database 130 of remote server 104 via network 102.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through network 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single entity. While private cloud 106 is depicted as being in communication with network 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Public cloud 105 and private cloud 106 are programmed and configured to deliver cloud computing services and/or microservices (not separately shown in FIG. 1). Unless otherwise indicated, the word “microservices” shall be interpreted as inclusive of larger “services” regardless of size. Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

As used herein, when used with reference to items, “a set of” means one or more of the items. For example, a set of clouds is one or more different types of cloud environments. Similarly, “a number of,” when used with reference to items, means one or more of the items. Moreover, “a group of” or “a plurality of” when used with reference to items, means two or more of the items.

Further, the term “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item B. This example may also include item A, item B, and item C or item B and item C. Of course, any combinations of these items may be present. In some illustrative examples, “at least one of” may be, for example, without limitation, two of item A, one of item B, and ten of item C, or four of item B and seven of item C, or other suitable combinations.

As human presence in space increases, one would expect more pressurized, human-habitable chambers, vessels, spacecrafts, and the like with human-breathable atmosphere to be in service. Monitoring the human-breathable atmosphere of these pressurized, human-habitable chambers for air leaks and other types of anomalies is needed. However, the monitoring should be routine and reliable. Illustrative embodiments can be deployed in any type of human-habitable microgravity space environment and can operate independently of other onboard systems (e.g., life support system, engine system, and the like) within the human-habitable microgravity space environment to detect anomalies (e.g., potential life support issues such as air leaks).

In addition to detecting air leaks in the human-habitable microgravity space environment, by understanding airflow within the human-habitable microgravity space environment illustrative embodiments can assist humans in placing sensors and organizing experiments, particularly those experiments involving molds, spores, dust, and other materials that can be affected by airflow. Further, illustrative embodiments can be applicable to monitoring equipment power consumption, thermal movements, and other aspects of spacecraft operations. Other use cases may include, for example, monitoring flow of pollutants within the human-habitable microgravity space environment, monitoring flow of heat that can be attributable to wear and tear of onboard equipment and components based on localized temperature changes, monitoring filter consumption in a ventilation system, monitoring health of humans by detecting clouds of droplets in the atmosphere caused by sneezing, coughing, bleeding, sweating, or the like, monitoring health of experiments, monitoring overall health of the environment, and the like.

Illustrative embodiments utilize a plurality of autonomous floaters (also known as airflow bots or robots) to hover or float in the human-habitable microgravity space environment and inside one or more gas-filled or liquid-filled chambers within the human-habitable microgravity space environment. A gas-filled chamber may be, for example, the human-habitable microgravity space environment, itself, a low-pressure CO² plant experiment container, or the like. A liquid-filled chamber may be, for example, a tank, pipe, reservoir, reaction chamber, circulation system, or the like for fuel, oxidizer, hydraulic fluid, water, coolant, refrigerant, stored liquified oxygen or nitrogen, or other working liquid. Applicable systems can include both closed and open systems. Examples of closed systems include refrigerant systems, hydraulic systems, and crewed spacecraft life support systems. Examples of open systems include supply tanks for fuel, oxidizer, reserve gas, and the like.

The autonomous floaters maintain or hold position by using onboard jets to adjust their positioning due to, for example, drift. The autonomous floaters may determine position using, for example, at least one of a set of optical or imaging devices (e.g., cameras), radar devices, lidar devices, radio frequency triangulation, and the like. The autonomous floaters record in a log the amount of thrust that the autonomous floaters use to maintain desired positioning as time series data. Illustrative embodiments utilize one or more onboard computers to perform a statistical analysis of the recorded time series data for anomaly detection. Alternative illustrative embodiments may utilize one or more earth-based computers, in addition to or instead of the one or more onboard computers, to perform the statistical analysis of the recorded time series data for anomaly detection. Alternative illustrative embodiments replace an instruction to maintain or hold position with an alternative flight path instruction, such as to fly a predetermined patrol route or to act as a swarm to autonomously achieve area coverage.

Illustrative embodiments may utilize existing or traditional statistical detection algorithms (e.g., time series anomaly detection algorithms) to identify unexpected airflow changes caused by, for example, an atmospheric leak through a hole in the environment or chamber. Illustrative embodiments may also use the statistical detection algorithms to identify baseline airflows, known artifacts such as a human floating by, and the like within human-habitable microgravity space environment. Furthermore, illustrative embodiments can perform a more detailed time series statistical analysis to reveal subtleties that impact spacecraft health, assist in designing systems or experiments, and the like. Moreover, illustrative embodiments may utilize machine learning techniques (e.g., reinforcement learning and the like) to enhance the resolution of a machine learning model, foundation model, or large language model over what is possible using time series analysis.

It should be noted that time series comparisons to a baseline is known and well-understood. For example, techniques from network security and intrusion detection may apply to anomaly (i.e., leak) detection. Illustrative embodiments may apply reinforcement learning to time series data to enhance the resolution of different events (e.g., detecting that a person is passing by an autonomous floater versus detecting that a particular person is passing by the autonomous floater). In addition, some desirable airflow data may not necessarily indicate an anomaly. For example, a human in the microgravity space environment may want to understand airflow for purposes of designing an experiment or engineering a system in the microgravity space environment. In the case of fluid flow, illustrative embodiments may use alternative techniques such as finite element analysis, Navier-stokes equations, or the like for fluid flow analysis and determination. Furthermore, illustrative embodiments may use covariance matrices and eigenvectors to detect anomalous patterns in the time series data.

Preferably, illustrative embodiments are applied in a microgravity space environment. For example, in a human-operated spacecraft, an autonomous floater may be in the way or disturbed by a passing human. If a human pushes the autonomous floater out of the way, then the autonomous floater will automatically return to its intended position and/or flight instruction after a predefined period such as five seconds, ten seconds, thirty seconds, one minute, or any other specified period of time, or a variable period of time determined by various factors, or randomly. In this situation where a human pushes the autonomous floater out of the way, a false positive anomalous signal will be generated. However, various techniques currently exist to account for and ignore such false positive anomalous signals. Examples include coupling autonomous floater thrust data with data provided by a nearby camera in the environment to ignore periods of human disruption as well as applying machine learning classification techniques to the time series data and/or anomalies to identify human interactions by their signature in the data.

Alternative illustrative embodiments may be applied on Earth as well, which will require constant opposition to the Earth's gravitational pull, either via buoyancy or other force holding the autonomous floater in the desired position using, for example, thrust from a rotor or tension force from a string. In such cases, the anomaly detection algorithm will account for the constant gravitational force (e.g., baseline versus thrust vector difference corresponding to anomalous time series data).

Thus, illustrative embodiments provide one or more technical solutions that overcome a technical problem with detecting anomalies in microgravity space environments. As a result, these one or more technical solutions provide a technical effect and practical application in the field of anomaly detection in a microgravity space environment.

With reference now to FIG. 2, a diagram illustrating an example of an anomaly detection system is depicted in accordance with an illustrative embodiment. Anomaly detection system 201 may be implemented in a computing environment, such as computing environment 100 in FIG. 1. Anomaly detection system 201 is a collection of hardware and software components for detecting anomalies, such as leaks, in human-habitable microgravity space environments based on analysis of time series data corresponding to autonomous floaters monitoring air or fluid flow within the human-habitable microgravity space environments.

In this example, anomaly detection system 201 is implemented in human-habitable microgravity space environment 202, such as human-habitable microgravity space environment 107 in FIG. 1. Human-habitable microgravity space environment 202 includes computer 204 and chamber 206. Computer 204 may be, for example, computer 101 in FIG. 1. Chamber 206 may represent the entire interior of human-habitable microgravity space environment 202 or only a portion of human-habitable microgravity space environment 202. However, it should be noted that human-habitable microgravity space environment 202 is intended as an example only and not as a limitation on illustrative embodiments. For example, human-habitable microgravity space environment 202 may include any number of computers, chambers, and other devices and components not shown.

Computer 204 includes anomaly detection code 208 such as anomaly detection code 200 in FIG. 1. In this example, chamber 206 encloses a human-breathable atmosphere. Alternatively, chamber 206 may contain a fluid, a gas, or a combination thereof. In addition, chamber 206 includes autonomous floaters 210. Autonomous floaters 210 represent a set of autonomous floaters that are designed and configured to monitor airflow in chamber 206.

Autonomous floaters 210 hover in defined positions inside chamber 206 of human-habitable microgravity space environment 202. Autonomous floaters 210 rely on microgravity so that autonomous floaters 210 can maintain or hold their defined positions with minimal energy usage. Autonomous floaters 210 maintain their defined positions using thrusting. Autonomous floaters 210 achieve thrusting in air via propellers, jets, valves, and the like. Autonomous floaters 210 can achieve thrusting in fluid via compressed fluid or using pass-through fluid.

Autonomous floaters 210 achieve position detection via, for example, at least one of a set of onboard radar devices, a set of onboard lidar devices, a set of onboard cameras, a set of offboard cameras located in chamber 206, or any other type of positioning system. Autonomous floaters 210 generate and transmit time series data corresponding to their thrusting to computer 204 for statistical anomaly detection analysis by anomaly detection code 208 to detect anomaly 212 in chamber 206. In this example, anomaly 212 represents a hole in chamber 206 allowing the human-breathable atmosphere to escape from chamber 206. In response to detecting anomaly 212, computer 204 performs a set of actions such as raising an alert to humans residing in human-habitable microgravity space environment 202.

In alternative illustrative embodiments, each of autonomous floaters 210 can collect, record, and analyze the thrusting time series data for anomaly detection. In other alternative illustrative embodiments, each of autonomous floaters 210 can collect and transmit its thrusting time series data to other autonomous floaters for data analysis via peer-to-peer communication.

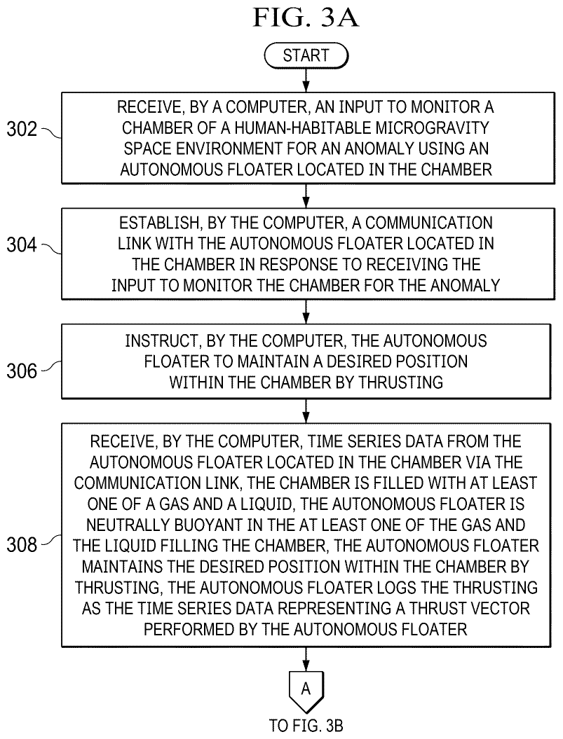

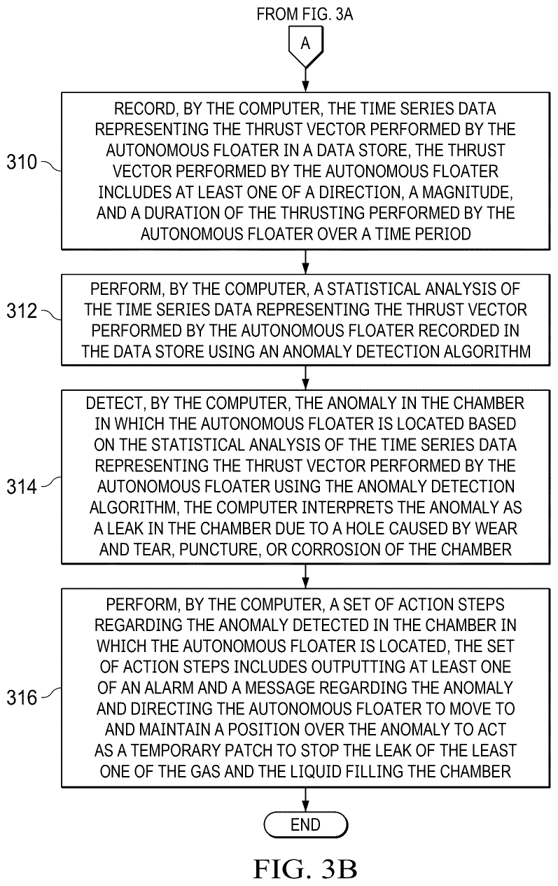

With reference now to FIGS. 3A-3B, a flowchart illustrating a process for detecting anomalies in microgravity space environments is shown in accordance with an illustrative embodiment. The process shown in FIGS. 3A-3B may be implemented in a computer, such as, for example, computer 101 in FIG. 1 or computer 204 in FIG. 2. For example, the process shown in FIGS. 3A-3B may be implemented by anomaly detection code 200 in FIG. 1 or anomaly detection code 208 in FIG. 2.

The process begins when the computer receives an input to monitor a chamber of a human-habitable microgravity space environment for an anomaly using an autonomous floater located in the chamber (step 302). The computer establishes a communication link with the autonomous floater located in the chamber in response to receiving the input to monitor the chamber for the anomaly (step 304). The computer instructs the autonomous floater to maintain a desired position within the chamber (step 306). For example, the computer may instruct the autonomous floater to maintain a particular flight pattern such as “hold position,” “fly this patrol route,” or the like.

The computer receives time series data from the autonomous floater located in the chamber via the communication link (step 308). The chamber is filled with at least one of a gas and a liquid. The autonomous floater is neutrally buoyant in the at least one of the gas and the liquid filling the chamber. The autonomous floater maintains the desired position within the chamber by thrusting. The autonomous floater logs the thrusting as the time series data representing a thrust vector performed by the autonomous floater. Determining the thrust vector from the autonomous floater's control outputs may be direct or inferred. As an example of directly determining a thrust vector, in an illustrative embodiment, an autonomous floater in a microgravity environment and fluid medium is equipped with jets oriented in several directions, and a log of which jet(s) are activated determines a thrust vector. As an example of an inferred thrust vector, an autonomous floater in an environment experiencing significant effective gravity may be equipped with a plurality of rotors that counter the local effective pull of gravity, and so the vector of a thrust may be computed from the relative activation of particular rotors as compared to others, thereby ignoring the lift component of the thrust needed to counter the locally experienced effective gravity.

The computer records the time series data representing the thrust vector performed by the autonomous floater in a data store (step 310). The thrust vector performed by the autonomous floater includes at least one of a direction, a magnitude, and a duration of the thrusting performed by the autonomous floater over a time period. The computer performs a statistical analysis of the time series data representing the thrust vector performed by the autonomous floater recorded in the data store using an anomaly detection algorithm (step 312).

The computer detects the anomaly in the chamber in which the autonomous floater is located based on the statistical analysis of the time series data representing the thrust vector performed by the autonomous floater using the anomaly detection algorithm (step 314). The computer interprets the anomaly as a leak in the chamber due to a hole caused by wear and tear, puncture, or corrosion of the chamber.

The computer performs a set of action steps regarding the anomaly detected in the chamber in which the autonomous floater is located (step 316). The set of action steps includes outputting at least one of an alarm and a message regarding the anomaly and directing the autonomous floater to move to and maintain a position over the anomaly to act as a temporary patch to stop the leak of the least one of the gas and the liquid filling the chamber. Thereafter, the process terminates.

Thus, illustrative embodiments of the present disclosure provide a computer-implemented method, computer system, and computer program product for detecting anomalies in microgravity space environments based on analysis of time series data obtained from autonomous floaters operating in the microgravity space environments. The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
performing, by a computer, a statistical analysis of time series data representing a thrust vector performed by an autonomous floater; and
detecting, by the computer, an anomaly in a chamber in which the autonomous floater is located based on the statistical analysis of the time series data representing the thrust vector performed by the autonomous floater.

2. The method of claim 1, further comprising:
performing, by the computer, a set of action steps regarding the anomaly detected in the chamber in which the autonomous floater is located.

3. The method of claim 1, further comprising:
receiving, by the computer, an input to monitor the chamber for the anomaly using the autonomous floater located in the chamber;
establishing, by the computer, a communication link with the autonomous floater located in the chamber in response to receiving the input to monitor the chamber for the anomaly;
instructing, by the computer, the autonomous floater to maintain a desired position within the chamber; and
receiving, by the computer, the time series data from the autonomous floater located in the chamber via the communication link, the autonomous floater maintains the desired position within the chamber by thrusting and logs the thrusting as the time series data representing the thrust vector performed by the autonomous floater.

4. The method of claim 1, wherein the statistical analysis is performed using an anomaly detection algorithm, and wherein the anomaly is interpreted as a leak in the chamber.

5. The method of claim 1, wherein the chamber is located in a microgravity environment.

6. The method of claim 1, wherein the chamber is filled with at least one of a gas and a liquid.

7. The method of claim 6, wherein the autonomous floater is neutrally buoyant in the at least one of the gas and the liquid filling the chamber.

8. The method of claim 1, wherein the statistical analysis is anomaly detection relative to a baseline such that the anomaly so-detected is a leak in the chamber.

9. The method of claim 1, wherein the chamber encloses a human-breathable atmosphere.

10. A computer system comprising:
a processor set;
one or more computer-readable storage media; and
program instructions stored on the one or more computer-readable storage media to cause the processor set to perform operations comprising:
performing a statistical analysis of time series data representing a thrust vector performed by an autonomous floater; and
detecting an anomaly in a chamber in which the autonomous floater is located based on the statistical analysis of the time series data representing the thrust vector performed by the autonomous floater.

11. The computer system of claim 10, wherein the operations further comprise:
performing a set of action steps regarding the anomaly detected in the chamber in which the autonomous floater is located.

12. The computer system of claim 10, wherein the operations further comprise:
receiving an input to monitor the chamber for the anomaly using the autonomous floater located in the chamber;
establishing a communication link with the autonomous floater located in the chamber in response to receiving the input to monitor the chamber for the anomaly;
instructing the autonomous floater to maintain a desired position within the chamber; and
receiving the time series data from the autonomous floater located in the chamber via the communication link, the autonomous floater maintains the desired position within the chamber by thrusting and logs the thrusting as the time series data representing the thrust vector performed by the autonomous floater.

13. A computer program product comprising:
one or more computer-readable storage media; and
program instructions stored on the one or more computer-readable storage media to perform operations comprising:
performing, by a computer, a statistical analysis of time series data representing a thrust vector performed by an autonomous floater; and
detecting, by the computer, an anomaly in a chamber in which the autonomous floater is located based on the statistical analysis of the time series data representing the thrust vector performed by the autonomous floater.

14. The computer program product of claim 13, wherein the operations further comprise:
performing, by the computer, a set of action steps regarding the anomaly detected in the chamber in which the autonomous floater is located.

15. The computer program product of claim 13, wherein the operations further comprise:
receiving, by the computer, an input to monitor the chamber for the anomaly using the autonomous floater located in the chamber;
establishing, by the computer, a communication link with the autonomous floater located in the chamber in response to receiving the input to monitor the chamber for the anomaly;
instructing, by the computer, the autonomous floater to maintain a desired position within the chamber; and
receiving, by the computer, the time series data from the autonomous floater located in the chamber via the communication link, the autonomous floater maintains the desired position within the chamber by thrusting and logs the thrusting as the time series data representing the thrust vector performed by the autonomous floater.

16. The computer program product of claim 13, wherein the statistical analysis is performed using an anomaly detection algorithm, and wherein the anomaly is interpreted as a leak in the chamber.

17. The computer program product of claim 13, wherein the chamber is located in a microgravity environment.

18. The computer program product of claim 13, wherein the chamber is filled with at least one of a gas and a liquid.

19. The computer program product of claim 18, wherein the autonomous floater is neutrally buoyant in the at least one of the gas and the liquid filling the chamber.

20. The computer program product of claim 13, wherein the statistical analysis is anomaly detection relative to a baseline thrust vector such that the anomaly so-detected is a leak in the chamber.
